(19) United States
(12) Patent Application Publication
(10) Pub. No.: US 2020/0408240 A1
(43) Pub. Date: Dec. 31, 2020

(54) BIDIRECTIONAL TAPERED THREAD TECHNOLOGY FOR COMBINING TECHNICAL CHARACTERISTICS OF CONE PAIR AND HELIX

(71) Applicant: AMICUS VERITATIS MACHINERY CO., LTD., Taizhou (CN)

(72) Inventor: Yihua YOU, TAIZHOU (CN)

(21) Appl. No.: 17/017,812

(22) Filed: Sep. 11, 2020

Related U.S. Application Data
(63) Continuation of application No. PCT/CN2019/081404, filed on Apr. 4, 2019.

(30) Foreign Application Priority Data
Apr. 7, 2018 (CN) 201810303075.5

(51) Int. Cl. F16B 33/02; F16B 39/30

(52) U.S. Cl. CPC F16B 33/02; F16B 39/30

(57) ABSTRACT

The present invention belongs to the technical field of device access, and relates to a bidirectional tapered thread technology for combining technical characteristics of a cone pair and a helix, so as to solve the problems of poor self-positioning and self-locking performance of existing threads, wherein an internal thread (6) is a bidirectional tapered hole (41) (non-entity space) in an inner surface of a cylindrical body (2); an external thread (9) is a bidirectional truncated cone body (71) (material entity) on an outer surface of a columnar body (3); and a complete unit thread is a helical bidirectional tapered body in an olive-like shape (93) and in a dumbbell-like (94), and can assimilate the traditional thread matched with the complete unit thread into a special truncated cone body (7) or special tapered hole (4).

### CROSS-REFERENCE TO RELATED APPLICATIONS

This application is a continuation of International Patent Application No. PCT/CN2019/081404, filed on Apr. 4, 2019, entitled “Bidirectional Tapered Thread Technology for Combing Technical Characteristics of Cone Pair and Helix,” which claims priority to China Patent Application No. 201810303075.5, filed on Apr. 7, 2018. The content of these identified applications are hereby incorporated by references.

### TECHNICAL FIELD

The present invention belongs to the field of general technology of device, and particularly relates to a bidirectional tapered thread technology for combining technical characteristics of a cone pair and a helix (hereinafter referred to as “bidirectional tapered thread technology”).

### BACKGROUND OF THE PRESENT INVENTION

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same thread profile and continuously protruding along a helical line on a cylindrical or conical surface; and the “thread body” refers to a material entity between adjacent flanks. This is also the definition of thread under global consensus.

The modern thread began in 1841 with British Whitworth thread. According to the theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder; and the flatter the inclined plane is, the greater the mechanical advantage is (see FIG. 19) (Jingshan Yang and Xiuya Wang, Discussion on the Principle of Screws, Disquisitiones Arithmeticae of Gauss).

The “principle of inclined plane” of the modern thread is an inclined plane slider model (see FIG. 20) which is established based on the law of inclined plane. It is believed that the thread pair meets the requirements of self-locking when a thread rise angle is less than or equal to the equivalent friction angle under the condition of little change of static load and temperature. The thread rise angle (see FIG. 21), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

The modern threads are abundant in types and forms, and are all tooth-shaped threads, which are determined by the technical principle, i.e., the principle of inclined plane. Specifically, the thread formed on a cylindrical surface is called cylindrical thread; the thread formed on a conical surface is called conical thread; and the thread formed on an end surface of the cylinder or the truncated cone is called plane thread. The thread formed on the surface of an outer circle of the body is called external thread; the thread formed on the surface of an inner round hole of the body is called internal thread; and the thread formed on the end surface of the body is called end face thread. The thread that the helical direction and the thread rise angle direction conform to the left-hand rule is called left-hand thread; and the thread that the helical direction and the thread rise angle direction conform to the right-hand rule is called right-hand thread. The thread having only one helical line in the same cross section of the body is called single-start thread; the thread having two helical lines is called double-start thread; and the thread having multiple helical lines is called multi-start thread. The thread having a triangular cross section is called triangular thread; the thread having a trapezoidal cross section is called trapezoidal thread; the thread having a rectangular cross section is called rectangular thread; and the thread having a zigzag cross section is called zigzag thread.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF THE INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide a bidirectional tapered thread technology with reasonable design, simple structure, and excellent connection performance and locking performance with respect to the above problems.

To achieve the above object, the following technical solution is adopted in the present invention: the bidirectional tapered thread technology for combining technical characteristics of the cone pair and the helix is a special thread pair technology combining technical characteristics of a cone pair and a helical movement, and comprises a unidirectional tapered thread and a bidirectional tapered thread. The unidirectional tapered thread is a helical technology for combining technical characteristics of a single cone body and a helical structure. The bidirectional tapered thread is a thread technology combining the technical characteristics of a bidirectional cone body and a helical structure. Only when the cone bodies are combined with the helical structure, that is, the cone bodies are linked together helically, internal and external cone bodies (including the single cone body and the bidirectional cone body, particularly the bidirectional cone body) of cone body having multiple pitches (i.e., more than one pitch) may compose a cone pair so as to form a thread pair. A bidirectional cone body is composed of two single cone bodies. The external cone body is a bidirectional truncated cone body, while the internal cone body is a bidirectional tapered hole. The two single cone bodies are respectively located on the left and right sides of the bidirectional cone body. Namely, the bidirectional cone body is composed of two single cone bodies in two directions, wherein the cone body has a left taper and a right taper reverse and/or opposite in direction and same and/or different in taper. The bidirectional truncated cone bodies are helically distributed on the outer surface of a columnar body to form the external thread; and/or the bidirectional tapered holes are helically distributed on the inner surface of a cylindrical body to form the internal thread. A complete unit thread is a bidirectional tapered geometric structure, including two special bidirectional tapered geometric structure, one is shaped like an olive and the other is shaped like a dumbbell. Namely, the complete unit thread of the bidirectional tapered thread comprises an olive-like shaped bidirectional tapered thread and a dumbbell-like shaped bidirectional tapered thread.

In the bidirectional tapered thread technology combining the technical characteristics of the cone pair and the helix, the definition of the bidirectional tapered thread can be expressed as “a special helical bidirectional tapered geometry, including the olive-like shaped bidirectional tapered geometry and the dumbbell-like shaped bidirectional tapered geometry, which has the bidirectional tapered holes (or bidirectional truncated cone bodies) with the specified left and right tapers reverse or opposite in direction and same and/or different in taper, and the bidirectional tapered holes (or bidirectional truncated cone bodies) are continuously (or discontinuously) distributed along the helical line”. The head or the tail of the bidirectional tapered thread may be an uncompleted bidirectional tapered geometry due to manufacturing and other reasons. Different from the modern thread technology, in terms of the quantity title of complete unit thread and/or incomplete unit thread, the bidirectional tapered thread is no longer based on “the number of threads” but based on “the number of pitches”. Namely, the bidirectional tapered thread may not be called a (the number of threads)-thread but called (the number of pitches)-pitch thread. The quantity title of the thread is changed on the basis of the change of technical connotation. The thread technology has changed from the engagement relationship between the internal thread and the external thread in the modern thread to the cohesion relationship between the internal thread and the external thread in the bidirectional tapered thread. Regardless of internal thread and external thread, the bidirectional tapered thread has two forms of a complete single-pitch thread, one is a special bidirectional tapered geometry which is olive-like shaped with a large middle and two small ends, and the other is a special bidirectional tapered geometry which is dumbbell-like shaped with a small middle and two large ends. The two forms are the same in technical principle, but different in geometric structure shapes of the threaded bodies.

The bidirectional tapered thread technology comprises a bidirectional truncated cone body helically distributed on an outer surface of a columnar body and a bidirectional tapered hole helically distributed on an inner surface of a cylindrical body. Namely, the bidirectional tapered thread technology comprises an external thread and an internal thread which are in mutual thread fit. The internal thread is the helically distributed bidirectional tapered hole; and the external thread is the helically distributed bidirectional truncated cone body. The internal thread is presented by the helical bidirectional tapered holes and in the form of a “non-entity space”; and the external thread is presented by the helical bidirectional truncated cone body and in the form of a “material entity”. The non-entity space refers to a space environment capable of accommodating the above material entity. The internal thread is a containing part; and the external thread is a contained part. The threads work in such a state that the internal thread and the external thread are fitted together by screwing the two bidirectional tapered geometries pitch by pitch, and the internal thread is cohered with the external thread till one side bears the load bidirectionally or both the left side and the right side bear the load bidirectionally at the same time or till the external thread and the internal thread are in interference fit. Whether the two sides bear bidirectional load at the same time is related to the actual working conditions in the application field. The bidirectional tapered hole contains and is fitted with the bidirectional truncated cone body pitch by pitch, i.e., the internal thread is fitted with the corresponding external thread pitch by pitch.

The thread connection pair is a thread pair formed by fitting a helical outer conical surface with a helical inner conical surface to form a cone pair. In the bidirectional tapered thread, both the outer conical surface of the external cone body and the inner conical surface of the internal cone body are bidirectional conical surfaces. When the thread connection pair is formed between the bidirectional tapered threads, a joint surface between the inner conical surface and the outer conical surface is used as a bearing surface; when the thread connection pair is formed between the bidirectional tapered thread and the traditional thread, a joint surface between the conical surface of the bidirectional tapered thread and the special conical surface of the traditional thread is used as a bearing surface. Namely, the conical surface is used as the bearing surface to realize the technical performance of connection. The self-locking, self-positioning, reusability, fatigue resistance and other capabilities of the thread pair mainly depend on size of the conical surfaces and taper of the cone pair forming the bidirectional tapered thread technology, i.e., the size of the conical surface and the taper of the internal thread and the external thread. The thread pair is a non-toothed thread.

Different from that the principle of inclined plane of the existing thread which shows a unidirectional force distributed on the inclined plane as well as an engagement relationship between the internal tooth bodies and the external tooth bodies, the bidirectional tapered thread is composed of two plain lines of the cone body in two directions (i.e. bidirectional state) when viewed from any cross section of the single cone body distributed on either left or right side along the cone axis. The plain line is the intersection line of the conical surfaces and a plane through which the cone axis passes through. The cone principle of the bidirectional tapered thread technology shows an axial force and a counter-axial force, both of which are combined by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone) is cohered with the corresponding tapered cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair, composed of the internal thread and the external thread in the traditional thread, which realizes its connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the inner conical surface of the internal cone body is cohered with the outer conical surface of the external cone body; and the inner conical surface is in close contact with the outer conical surface. The axial force of the internal cone and the counter-axial force of the external cone are concepts of forces unique to the bidirectional tapered thread technology, i.e., the cone pair technology, in the present invention.

The internal cone body exists in a form similar to a shaft sleeve, and generates the axial force pointing to or pressing toward the cone axis under the action of external load. The axial force is bidirectionally combined by a pair of centripetal forces which are distributed in mirror image with the cone axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are engaged till interference is achieved, so the axial force and the counter-axial force generate a pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be engaged with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. The above pressure is essential for the cone pair to generate self-locking, is mainly related to the conical surface and taper size of the conical bodies forming the cone pair, and also has some relationship to an external load borne by the inner and outer conical bodies while forming the cone pair. Further, under an action condition of a rated external load, i.e., when the external load borne by the inner and outer conical bodies of the cone pair forming the above thread technology in the present invention is an invariant, that is, in a situation or circumstance of the action condition of certain external loads of the same size, the pressure generated between the inner and outer conical bodies forming the cone pair is inversely proportional to tangent of a half taper angle of the cone body, that is, the pressure generated between the inner and outer conical bodies forming the cone pair under the action of the rated external load is inversely proportional to tangent of ½ taper angle, i.e., a half taper angle, of a taper angle corresponding to taper of the above inner and outer conical bodies (that is, internal and external thread bodies in accordance with the technical spirit of the present invention). However, not any axial force angle and/or counter-axial force angle may enable the cone pair to produce self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation until the cone pair completely has no self-locking ability; and the axial bearing capacity changes in a direction of enhancement until the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation until the cone pair is close to have has no self-positioning ability at all.

Compared technology with the containing and contained relationship of irreversible one-sided bidirectional containment that the unidirectional tapered thread of single cone body invented by the applicant before which can only bear the load by one side of the conical surface, the thread connection pair of the bidirectional tapered thread technology of the present disclosure allows the reversible left and right-sided bidirectional containment of the bidirectional tapered threads of double cone bodies, enabling the left side and/or the right side of the conical surface to bear the load, and/or the left conical surface and the right conical surface to respectively bear the load, and/or the left conical surface and the right conical surface to simultaneously bear the load bidirectionally, and further limiting a disordered degree of freedom between the tapered hole and the truncated cone body; and the helical movement enables the thread connection pair to obtain a necessary ordered degree of freedom, thereby effectively combining the technical characteristics of the cone pair and the thread pair to form a brand-new thread technology.

When the bidirectional tapered thread technology is used in thread fit, the conical surface of the bidirectional truncated cone body and the conical surface of the bidirectional tapered hole are fitted with each other, or may be used solely or respectively combined with other non-thread machinery.

The self-locking and/or self-positioning of the thread connection pair is not realized at any taper or any taper angle of the internal and external bidirectional cone bodies, i.e., the truncated cone body and/or tapered hole of the internal and external bidirectional cone bodies of the bidirectional tapered thread of the bidirectional tapered thread technology. The thread connection pair has the self-locking and self-positioning performances only when the internal cone body and the external cone body reach a certain taper, i.e., the cone bodies of the cone pair forming the present bidirectional tapered thread connection pair reach a certain taper angle. The taper comprises the left taper and the right taper of the internal thread and the external thread. The taper angle comprises a left taper angle and a right taper angle of the internal and external thread bodies. The bidirectional tapered thread technology is composed of three forms of bidirectional tapered threads, the first one is that the left taper of the bidirectional tapered thread is the same as the right taper; the second one is that the left taper of the bidirectional tapered thread is greater than the right taper, i.e., the right taper is smaller than the left taper; and the last one is that the left taper of the bidirectional tapered thread is smaller than the right taper, i.e., the right taper is greater than the left taper. The former one is a symmetric bidirectional tapered thread, while the latter two are asymmetric bidirectional tapered threads. The left taper corresponds to the left taper angle. The left taper angle is the first taper angle α1. The right taper corresponds to the right taper angle. The right taper angle is the second taper angle α2.

In the bidirectional tapered thread technology, when the tapered thread is symmetric bidirectional tapered thread, i.e., the left taper is the same as and/or approximately the same as the right taper, it is preferable that the first taper angle α1 is greater than 0° and smaller than 53°; and preferably, the first taper angle α1 is 2°-40°. It is preferable that the second taper angle α2 is greater than 0° and smaller than 53°; and preferably, the second taper angle α2 is 2°-40°. In individual special fields, it is preferable that the first taper angle α1 is greater than or equal to 53° and smaller than 180°; the second taper angle α2 is greater than or equal to 53° and smaller than 180°; and preferably, both the first taper angle α1 and the second taper angle α2 are 53°-90°.

When the tapered thread is an asymmetric bidirectional tapered thread and the left taper is greater than the right taper, it is preferable that the first taper angle α1 is greater than 0° and smaller than 53°; and preferably, the first taper angle α1 is 2°-40°. In individual special fields, it is preferable that the first taper angle α1 is greater than or equal to 53° and smaller than 180°; and preferably, the first taper angle α1 is 53°-90°. It is preferable that the second taper angle α2 is greater than 0° and smaller than 53°; and preferably, the second taper angle α2 is 2°-40°.

When the tapered thread is the asymmetric bidirectional tapered thread and the left taper is smaller than the right taper, it is preferable that the first taper angle α1 is greater than 0° and smaller than 53°; and preferably, the first taper angle α1 is 2°-40°. It is preferable that the second taper angle α2 is greater than 0° and smaller than 53°; and preferably, the second taper angle α2 is 2°-40°. In individual special fields, it is preferable that the second taper angle α2 is greater than or equal to 53° and smaller than 180°; and preferably, the second taper angle α2 is 53°-90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

The external thread of the bidirectional tapered thread technology is arranged on the outer surface of the columnar body, wherein a screw body is arranged on the columnar body; the truncated cone body is helically distributed on the outer surface of the screw body, comprising a bidirectional truncated cone body. The asymmetric bidirectional truncated cone body has two structural forms, one is a special bidirectional tapered geometry in an olive-like shape; and the other is a special bidirectional tapered geometry in a dumbbell-like shape. The columnar body may be solid or hollow, comprising cylindrical and/or non-cylindrical workpieces and objects that need to be machined with threads on outer surfaces thereof, wherein the outer surfaces include cylindrical surfaces, non-cylindrical surfaces such as conical surfaces, and outer surfaces of other geometric shapes.

For the bidirectional tapered thread technology, the bidirectional truncated cone body in the olive-like shape, i.e., the external thread formed by symmetrically and oppositely lower bottom surfaces of two truncated cone bodies with the same lower bottom surfaces and upper top surfaces and same cone height and/or different cone heights, and the upper top surfaces are located at both ends of the bidirectional truncated cone body to form the bidirectional tapered thread, comprising that the lower bottom surfaces are respectively jointed with the upper top surfaces of the adjacent bidirectional truncated cone bodies and/or to be respectively jointed with the upper top surfaces of the adjacent bidirectional truncated cone bodies in the helical shape to form the thread. The external thread comprises a first helical conical surface of the truncated cone body, a second helical conical surface of the truncated cone body and an external helical line, which form a bidirectional tapered external thread. In a cross section through which the thread axis passes, a complete single-pitch bidirectional tapered external thread is a special bidirectional tapered geometry in the olive-like shape small in the middle and large in both ends. The bidirectional truncated cone body comprises conical surfaces of the bidirectional truncated cone body. The angle formed between the two plain lines of the left conical surface of the bidirectional truncated cone body, i.e., the first helical conical surface of the truncated cone body, is the first taper angle. The left taper is formed on the first helical conical surface of the truncated cone body and is subjected to a left-direction distribution. The angle formed between the two plain lines of the right conical surface of the bidirectional truncated cone body, i.e., the second helical conical surface of the truncated cone body, is the second taper angle. The right taper is formed on the second helical conical surface of the truncated cone body is subjected to a right-direction distribution. The taper directions corresponding to the first taper angle and the second taper angle are opposite. The plain line is an intersection line of the conical surface and the plane through which the cone axis passes. A shape formed by the first helical conical surface and the second helical conical surface of the truncated cone body of the bidirectional truncated cone body is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body, wherein the right-angled side is coincident with the central axis of the columnar body; and the right-angled trapezoid union is formed by symmetrically and oppositely jointing lower sides of two right-angled trapezoids with the same lower sides and upper sides and same right-angled side and/or different right-angled sides. The right-angled trapezoid union refers to a special geometry, which is formed by symmetrically and oppositely jointing the lower sides of two right-angled trapezoids with the same lower sides and upper sides and same right-angled side and/or different right-angled sides and has the upper sides respectively located at both ends of the right-angled trapezoid union.

For the bidirectional tapered thread technology, the bidirectional truncated cone body in the dumbbell-like shape, i.e., the external thread is formed by symmetrically and oppositely jointing upper top surfaces of two truncated cone bodies with the same lower bottom surfaces and upper top surfaces and same cone height and/or different cone heights, and the lower bottom surfaces are located at both ends of the bidirectional truncated cone body to form the bidirectional tapered thread, comprising that the upper top surfaces are respectively jointed with the lower bottom surfaces of the adjacent bidirectional truncated cone bodies and/or to be respectively jointed with the lower bottom surfaces of the adjacent bidirectional truncated cone bodies in the helical shape to form the thread. The external thread comprises a first helical conical surface of the truncated cone body, a second helical conical surface of the truncated cone body and an external helical line, which form the bidirectional tapered external thread. In a cross section through which the thread axis passes, a complete single-pitch bidirectional tapered external thread, is a special bidirectional tapered geometry in the dumbbell-like shape small in the middle and large in both ends. The bidirectional truncated cone body comprises a conical surface of the bidirectional truncated cone body. The angle formed between the two plain lines of the left conical surface of the bidirectional truncated cone body, i.e., the first helical conical surface of the truncated cone body, is the first taper angle. The left taper is formed on the first helical conical surface of the truncated cone body and is subjected to a right-direction distribution. The angle formed between the two plain lines of the right conical surface of the bidirectional truncated cone body, i.e., the second helical conical surface of the truncated cone body, is the second taper angle. The right taper is formed on the second helical conical surface of the truncated cone body and is subjected to a left-direction distribution. The taper directions corresponding to the first taper angle and the second taper angle are opposite. The plain line is an intersection line of the conical surface and the plane through which the cone axis passes. A shape formed by the first helical conical surface and the second helical conical surface of the truncated cone body of the bidirectional truncated cone body is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body, wherein the right-angled side is coincident with the central axis of the columnar body; and the right-angled trapezoid union is formed by symmetrically and oppositely jointing upper sides of two right-angled trapezoids with the same lower sides and upper sides and same and/or different right-angled sides. The right-angled trapezoid union refers to a special geometry, which is formed by symmetrically and oppositely jointing the upper sides of two right-angled trapezoids with the same lower sides and upper sides and same and/or different right-angled sides and has the lower sides respectively located at both ends of the right-angled trapezoid union.

The internal thread of the bidirectional tapered thread technology is arranged in the inner surface of the cylindrical body, wherein the cylindrical body is provided with a nut body; the tapered hole is helically distributed on the inner surface of the nut body, comprising the bidirectional tapered hole. The bidirectional tapered hole has two structural forms, wherein one is a special bidirectional tapered geometry in the olive-like shape; and the other is a special bidirectional tapered geometry in the dumbbell-like shape. The cylindrical body comprises cylindrical and/or non-cylindrical workpieces and objects which need to be machined with the internal threads in inner surfaces thereof, wherein the inner surfaces include geometric shapes of inner surfaces such as cylindrical surfaces, non-cylindrical surfaces such as conical surfaces, and the like.

For the bidirectional tapered thread technology, when the bidirectional tapered hole in the olive-like shape, i.e., the internal thread, is formed by symmetrically and oppositely jointing lower bottom surfaces of two tapered holes with the same lower bottom surfaces and upper top surfaces and same cone height and/or different cone heights , and the upper top surfaces are located at both ends of the bidirectional tapered hole to form the bidirectional tapered thread, comprising that the lower bottom surfaces are respectively jointed with the upper top surfaces of the adjacent bidirectional tapered holes and/or to be respectively jointed with the upper top surfaces of the adjacent bidirectional tapered holes in the helical shape to form the thread. The internal thread comprises a first helical conical surface of the tapered hole, a second helical conical surface of the tapered hole and an internal helical line, which form a bidirectional tapered internal thread. In the cross section passing through the thread axis, a complete single-pitch bidirectional tapered internal thread, is a special bidirectional tapered geometry in the olive-like shape and with a large middle and two small ends. The bidirectional tapered hole comprises a conical surface of the bidirectional tapered hole. The angle formed by the two plain lines of the left conical surface of the bidirectional tapered hole, i.e., the first helical conical surface of the tapered hole, is the first taper angle. The left taper is formed on the first helical conical surface of the tapered hole and is subjected to the left-direction distribution. The angle formed by the two plain lines of the right conical surface, i.e., the second helical conical surface of the tapered hole, is the second taper angle. The right taper is formed on the second helical conical surface of the tapered hole and is subjected to the right-direction distribution. The taper directions corresponding to the first taper angle and the second taper angle are opposite. The plain line is an intersection line of the conical surface and the plane through which the cone axis passes. A shape formed by the first helical conical surface and the second helical conical surface of the tapered hole of the bidirectional tapered hole is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body, wherein the right-angled side is coincident with the central axis of the cylindrical body; and the right-angled trapezoid union is formed by symmetrically and oppositely jointing lower sides of two right-angled trapezoids with the same lower sides and upper sides and same and/or different right-angled sides. The right-angled trapezoid union refers to a special geometry, which is formed by symmetrically and oppositely jointing the lower sides of two right-angled trapezoids with the same lower sides and upper sides and same and/or different right-angled sides and has the upper sides respectively located at both ends of the right-angled trapezoid union.

For the bidirectional tapered thread technology, the bidirectional tapered hole in the dumbbell-like shape, i.e., the internal thread, is formed by symmetrically and oppositely jointing upper top surfaces of two tapered holes with the same lower bottom surfaces and upper top surfaces and different cone heights, and the lower bottom surfaces are located at both ends of the bidirectional tapered hole to form the bidirectional tapered thread, comprising that the upper top surfaces are respectively jointed with the lower bottom surfaces of the adjacent bidirectional tapered holes and/or to be respectively jointed with the lower bottom surfaces of the adjacent bidirectional tapered holes in the helical shape to form the thread. The internal thread comprises the first helical conical surface of the tapered hole, the second helical conical surface of the tapered hole and the internal helical line, which form the bidirectional tapered internal thread. In the cross section passing through the thread axis, the complete single-pitch bidirectional tapered internal thread, is a special bidirectional tapered geometry in the dumbbell-like shape and with a small middle and two large ends. The bidirectional tapered hole comprises a conical surface of the bidirectional tapered hole. The angle formed by the two plain lines of the left conical surface of the bidirectional tapered hole, i.e., the first helical conical surface of the tapered hole, is the first taper angle. The left taper is formed on the first helical conical surface of the tapered hole and is subjected to the right-direction distribution. The angle formed by the two plain lines of the right conical surface of the bidirectional tapered hole, i.e., the second helical conical surface of the tapered hole, is the second taper angle. The right taper is formed on the second helical conical surface of the tapered hole and is subjected to the left-direction distribution. The taper directions corresponding to the first taper angle and the second taper angle are opposite. The plain line is an intersection line of the conical surface and the plane through which the cone axis passes. A shape formed by the first helical conical surface and the second helical conical surface of the tapered hole of the bidirectional tapered hole is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body, wherein the right-angled side is coincident with the central axis of the cylindrical body; and the right-angled trapezoid union is formed by symmetrically and oppositely jointing upper sides of two right-angled trapezoids with the same lower sides and upper sides and same and/or different right-angled sides. The right-angled trapezoid union refers to a special geometry, which is formed by symmetrically and oppositely jointing the upper sides of two right-angled trapezoids with the same lower sides and upper sides and same and/or different right-angled sides and has the lower sides respectively located at both ends of the right-angled trapezoid union.

In specific application, the bidirectional tapered threads of two types, i.e., the bidirectional tapered threads in the olive-like shape and the dumbbell-like shape, form a thread connection pair. The condition is complex, i.e., the above internal thread and the external thread form the thread connection pair, that is, the external thread and the internal thread are in mutual screw-thread fit. The internal thread and the external thread may be a combination of bidirectional tapered threads of the same type, and may also be a combination of bidirectional tapered threads of different types, comprising: a combination of the olive-like shaped bidirectional tapered threads and/or a combination of the dumbbell-like shaped bidirectional tapered threads and/or a mixed combination of the olive-like shaped and dumbbell-like shaped bidirectional tapered threads; and/or comprising a combination of the olive-like shaped bidirectional tapered threads and/or a combination of the dumbbell-like shaped bidirectional tapered threads and/or a mixed combination of the olive-like shaped and dumbbell-like shaped bidirectional tapered threads when the internal and external threads form the thread connection pair with the traditional threads. Due to the above different combinations of the internal thread and the external thread comprising the olive-like shaped and dumbbell-like shaped bidirectional tapered threads, the first helical conical surface of the tapered hole, the second helical conical surface of the tapered hole, the first helical conical surface of the truncated cone body and the second helical conical surface of the truncated cone body serve as fitted helical conical surfaces of a thread operation bearing surface so as to obtain combination changes. After the thread connection pair is formed in the bidirectional tapered thread technology, a cooperative relationship between the inner and outer conical surfaces always occurs between the internal thread and the external thread, i.e., a cooperative relationship between the helical inner conical surface and helical outer conical surface occurs. Thus, a cone pair is formed so as to form the thread pair. However, the technical principle is the same for any combination.

Due to the unique technical characteristic and advantage that a thread body of the bidirectional tapered thread is a tapered body (comprising as follows: the inner tapered body is “tapered hole” and the outer tapered body is “taper”, i.e., the internal thread is a tapered hole and the external thread is a truncated cone body), a bidirectional tapered internal thread and/or a bidirectional tapered external thread may be used solely or combined with other mechanical forms. The other mechanical forms include but not limited to mechanical parts or mechanical components such as a non-thread mechanical structure and/or mechanical elements that are related to the mechanical structure and are important elements of the content of the mechanical structure, and have higher capabilities of assimilative threads of different types, i.e., capabilities of assimilating traditional threads fitted with the threads into tapered threads of special forms having the same technical characteristics and properties. The traditional threads assimilated by the tapered threads are dissimilated traditional threads. It seems that, the appearance of the thread body is not much different from the traditional thread body. However, the bidirectional tapered thread has no substantive technical content of the thread body of the traditional thread. The thread body is the special tapered geometry changing from the properties of the original traditional thread body to properties of a thread body having a tapered thread, that is, properties and technical characteristics of the tapered body. The special tapered geometry is radially provided with a special conical surface matched with the helical conical surface of the tapered thread. The above traditional threads include triangular threads, trapezoidal threads, sawtooth threads, rectangular threads, arc threads and other geometric threads that may be screwed with the bidirectional tapered thread so as to form the thread connection pair, but not limited to the above threads. Then, the traditional thread is not a traditional thread in the proper sense, but a special tapered thread assimilated by the tapered thread. A contact part of the traditional thread and the tapered thread forms an inner surface and/or an outer surface of the special tapered geometry that can be matched with a helical conical surface of the tapered thread. The traditional internal thread is a special tapered hole, while the traditional external thread is a special truncated cone body. A special conical surface is formed on the special tapered geometry. The above special conical surface comprises a conical surface of the special tapered hole and a conical surface of the special truncated cone body. With the increase of screwing use times, an effective conical surface area of the special conical surface on the special tapered hole (or the special truncated cone body) of the traditional thread to be continuously increased, that is, the special conical surface may be continuously enlarged and tends to have direction change of a larger contact surface with the helical conical surface of the bidirectional tapered thread. Substantially, the special tapered geometry, i.e., the special tapered hole (or the special truncated cone body) that is incomplete in tapered geometry but has the technical spirit of the present invention is formed. Further, the special tapered hole is a thread body assimilated by the traditional internal thread due to cohered contact with the bidirectional tapered external thread, and is the special tapered geometry transformed from the traditional internal thread. The special tapered hole is radially provided with an inner surface that can be fitted with the conical surface of the bidirectional truncated cone body, i.e., the conical surface of the special tapered hole. The special truncated cone body is a thread body assimilated by the traditional external thread due to cohered contact with the bidirectional tapered internal thread, and is the special tapered geometry transformed from the traditional external thread. The special truncated cone body is radially provided with an outer surface that can be fitted with the conical surface of the bidirectional tapered hole, i.e., the conical surface of the truncated cone body. The thread connection pair is formed as follows: the helical special conical surface, i.e., a special conical surface of the special tapered hole (or the special truncated cone body) formed from the traditional thread due to contact with the bidirectional tapered thread, and the helical conical surface of the bidirectional tapered thread are fitted with each other to form a cone pair so as to form the thread pair. The traditional thread assimilated by the tapered thread is a dissimilated traditional thread. The special conical surface of the dissimilated traditional thread appears in the form of lines. Moreover, with the increase of the contact use times of the crest of the traditional thread and the tapered hole (or the truncated cone body) of the bidirectional tapered thread, the special conical surfaces are gradually increased. Namely, the special conical surface of the traditional thread is continuously changed and enlarged from microscopic surface (macroscopic line) to macroscopic surface; or a conical surface fitted with the bidirectional tapered thread may be directly machined at the crest of the traditional thread. All the characteristics should be in accordance with the technical spirit of the present invention.

The bidirectional tapered thread technology has characteristics that, the internal thread comprises a bidirectional tapered internal thread and a traditional internal thread; and the external thread comprises a bidirectional tapered external thread and a traditional external thread.

The technical performance of the bidirectional tapered thread technology is realized by cohesion connection of the bidirectional tapered hole and the bidirectional truncated cone body. According to application conditions, one direction of the left and/or the right and/or one direction of the left and the right and/or one direction of the right and the left bears sizing fit, and/or two directions of the left and the right simultaneously respectively bear the sizing fit and/or until sizing interference contact is achieved. Namely, under the guidance of the helical line, the inner and outer diameters of the internal cone and the external cone of the bidirectional truncated cone body and the bidirectional tapered hole are centered until the cones are engaged to bear the sizing fit in one direction or to bear the sizing fit in the two directions simultaneously or until the sizing interference contact is achieved, that is, the first helical conical surface of the truncated cone body and the first helical conical surface of the tapered hole are in sizing fit and/or sizing interference contact is achieved, and/or the second helical conical surface of the truncated cone body and the second helical conical surface of the tapered hole are in sizing fit and/or sizing interference contact is achieved, and/or the first helical conical surface of the truncated cone body and the second helical conical surface of the tapered hole are in sizing fit and/or sizing interference contact is achieved, and/or the second helical conical surface of the truncated cone body and the first helical conical surface of the tapered hole are in sizing fit and/or sizing interference contact is achieved.

Since the bidirectional internal cone contains the bidirectional external cone, by virtue of positioning in multiple directions such as radial, axial, angular and circumferential, it is preferable that, through the containment of the bidirectional truncated cone body (or the special truncated cone body) by the bidirectional tapered hole (or the special tapered hole) and the main positioning in the radial and circumferential directions supplemented by the auxiliary positioning in the axial and angular directions, so as to form multidirectional positioning of the internal and external cone bodies, until the conical surface of the bidirectional tapered hole (or the conical surface of the special tapered hole) is engaged with the conical surface of the bidirectional truncated cone body (or the conical surface of the special truncated cone body) to implement self-positioning or until the sizing interference contact is achieved to generate self-locking, which constitutes a special technology of the cone pair and the thread pair, thereby realizing technical performances such as connection, locking, anti-loosening, bearing, transmission, fatigue and seal of mechanical structures.

Therefore, the technical performances such as the transmission precision and efficiency, the load bearing capacity, the locking force of self-locking, the anti-loosening ability and the sealing performance of the bidirectional tapered thread technology are related to the sizes of the first helical conical surface of the truncated cone body and the formed left taper, i.e., the first taper angle α1, the second helical conical surface of the truncated cone body and the formed right taper, i.e., the second taper angle α2, the first helical conical surface of the tapered hole and the formed left taper, i.e., the first taper angle α1, as well as the second helical conical surface of the tapered hole and the formed right taper, i.e., the second taper angle α2. Material friction coefficient, processing quality and application conditions of the columnar body and the cylindrical body also have a certain impact on the cone fit.

In the bidirectional tapered thread technology, when the right-angled trapezoid union rotates a circle at a constant speed, an axial movement distance of the right-angled trapezoid union is at least double a length of the sum of the right-angled sides of the two right-angled trapezoids with the same lower sides and upper sides and same right-angled side and/or different right-angled sides. The structure ensures that the first helical conical surface and the second helical conical surface of the truncated cone body as well as the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

According to the bidirectional tapered thread technology, when the right-angled trapezoid union rotates a circle at a constant speed, an axial movement distance of the right-angled trapezoid union is equal to a length of the sum of the right-angled sides of two right-angled trapezoids with the same lower sides and upper sides and same right-angled side and/or different right-angled sides. The structure ensures that the first helical conical surface of the truncated cone body and the second helical conical surface of the truncated cone body as well as the first helical conical surface of the tapered hole and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

According to the bidirectional tapered thread technology, the first helical conical surface of the truncated cone body, the second helical conical surface of the truncated cone body, the first helical conical surface of the tapered hole and the second helical conical surface of the tapered hole are continuous helical surfaces or discontinuous helical surfaces. Preferably, the first helical conical surface of the truncated cone body, the second helical conical surface of the truncated cone body as well as the first helical conical surface of the tapered hole and the second helical conical surface of the tapered hole are all continuous helical surfaces.

Compared with the prior art, the bidirectional tapered thread technology has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions.

### DESCRIPTION OF THE DRAWINGS

FIG. 1 is a structural schematic diagram of a typical thread connection pair of a bidirectional tapered thread technology in Embodiment 1 provided by the present invention; the diagram looks like a structural form of the thread connection pair, but substantially can accurately reflect and include a structural schematic diagram of rich thread pair structure connotation of multiple thread connection pairs in accordance with technical spirit of the present invention, comprising a symmetric bidirectional tapered thread connection pair in an olive-like shape and/or a symmetric bidirectional tapered thread connection pair in a dumbbell-like shape and/or a mixed thread connection pair between symmetric bidirectional tapered external threads in an olive-like shape and symmetric bidirectional tapered internal threads in a dumbbell-like shape and/or a mixed thread connection pair between symmetric bidirectional tapered external threads in a dumbbell-like shape and symmetric bidirectional tapered internal threads in an olive-like shape;

FIGS. 2A-2B are structural schematic diagrams of an internal thread, an external thread of a bidirectional tapered thread in an olive-like shape and a complete unit thread thereof in Embodiment 1 provided by the present invention; wherein FIG. 2A is the structural schematic diagram of the external thread of the symmetric bidirectional tapered thread in the olive-like shape; FIG. 2B is the structural schematic diagram of the internal thread of the symmetric bidirectional tapered thread in the olive-like shape;

FIGS. 3A-3B are structural schematic diagrams of an internal thread, an external thread of a symmetric bidirectional tapered thread in a dumbbell-like shape and a complete unit thread thereof in Embodiment 1 provided by the present invention; wherein FIG. 3A is the structural schematic diagram of the external thread of the symmetric bidirectional tapered thread in the dumbbell-like shape; FIG. 3B is the structural schematic diagram of the internal thread of the symmetric bidirectional tapered thread in the dumbbell-like shape;

FIG. 4 is a relational graph of axial force and counter-axial force of a cone pair in a bidirectional tapered thread technology for combining technical characteristics of a cone pair and a helix provided by the present invention;

FIG. 5 is a critical relational graph of axial force and counter-axial force of a cone pair comprising achievement of self-positioning and/or self-locking in a bidirectional tapered thread technology for combining technical characteristics of a cone pair and a helix provided by the present invention;

FIGS. 6A-6B are structural schematic diagrams of an internal thread and an external thread of an asymmetric bidirectional tapered thread in an olive-like shape (a left taper greater than a right taper) and a complete unit thread thereof; wherein FIG. 6A is the structural schematic diagram of the internal thread of the asymmetric bidirectional tapered thread in the olive-like shape (the left taper greater than a right taper); FIG. 6B is the structural schematic diagram of the external thread of the asymmetric bidirectional tapered thread in the olive-like shape (the left taper greater than a right taper).

FIGS. 7A-7B are structural schematic diagrams of an internal thread and an external thread of a asymmetric bidirectional tapered thread in a dumbbell-like shape (the left taper smaller than the right taper) and a complete unit thread thereof; wherein FIG. 7A is the structural schematic diagram of the internal thread of the asymmetric bidirectional tapered thread in the dumbbell-like shape (the left taper is smaller than the right taper); FIG. 7B is the structural schematic diagram of the external thread of the asymmetric bidirectional tapered thread in the dumbbell-like shape (the left taper is smaller than the right taper);

FIGS. 8A-8B are structural schematic diagrams of an internal thread and an external thread of the asymmetric bidirectional tapered thread in the olive-like shape (the left taper greater than the right taper) and a complete unit thread thereof according to the present invention; wherein FIG. 8A is the structural schematic diagram of the internal thread of the asymmetric bidirectional tapered thread in the olive-like shape (the left taper greater than the right taper); FIG. 8B is the structural schematic diagram of the external thread of the asymmetric bidirectional tapered thread in the olive-like shape (the left taper greater than the right taper);

FIGS. 9A-9B are structural schematic diagrams of an internal thread and an external thread of the asymmetric bidirectional tapered thread in the dumbbell-like shape (the left taper smaller than the right taper) and a complete unit thread according to the present invention; wherein FIG. 9A is the structural schematic diagram of the internal thread of the asymmetric bidirectional tapered thread in the dumbbell-like shape (the, left taper smaller than the right taper); FIG. 9B is the structural schematic diagram of the external thread of the asymmetric bidirectional tapered thread in the dumbbell-like shape (the left taper smaller than the right taper);

FIG. 10 is a structural schematic diagram of a symmetric bidirectional tapered thread connection pair in an olive-like shape in a detail drawing of FIG. 1 according to the present invention;

FIG. 11 is a structural schematic diagram of a symmetric bidirectional tapered thread connection pair in a dumbbell-like shape in a detail drawing of FIG. 1 according to the present invention;

FIG. 12 is a structural schematic diagram of a thread connection pair of a mixed combination of a symmetric bidirectional tapered external thread in an olive-like shape and a symmetric bidirectional tapered internal thread in a dumbbell-like shape in a detail drawing of FIG. 1 according to Embodiment 1 of the present invention;

FIG. 13 is a structural schematic diagram of a thread connection pair of a mixed combination of a symmetric bidirectional tapered external thread in a dumbbell-like shape and a symmetric bidirectional tapered internal thread in an olive-like shape in a detail drawing of FIG. 1 according to Embodiment 1 of the present invention;

FIG. 14 is a schematic diagram of a connection structure between double nuts comprising a double-nut combined asymmetric bidirectional tapered thread in an olive-like shape (the left taper smaller than the right taper) and an asymmetric bidirectional tapered thread in a dumbbell-like shape (the left taper smaller than the right taper) and a traditional thread bolt

FIG. 15 is a structural schematic diagram of a nut body asymmetric bidirectional tapered internal thread in an olive-like shape (the left taper greater than the right taper) in FIG. 14 and a complete unit thread thereof according to the present invention;

FIG. 16 is a structural schematic diagram of a nut body asymmetric bidirectional tapered internal thread in a dumbbell-like shape (the left taper greater than the right taper) in FIG. 14 and a complete unit thread thereof according to the present invention;

FIG. 17 is a schematic diagram of a connection structure between bolts comprising an asymmetric bidirectional tapered thread in an olive-like shape (the left taper greater than the right taper) and an asymmetric bidirectional tapered thread in a dumbbell-like shape (the left taper greater than the right taper) and a mixed combination of double nuts of the traditional internal thread according to the present invention;

FIG. 18 is a structural schematic diagram of bolts of two asymmetric bidirectional tapered external threads, i.e., an asymmetric bidirectional tapered external thread in an olive-like shape (the left taper greater than the right taper) and an asymmetric bidirectional tapered external thread in a dumbbell-like shape (the left taper greater than the right taper), and a complete unit thread of the external thread;

FIG. 19 is a graphic presentation of that “the thread of the existing thread technology is an inclined plane on a cylindrical or conical surface” involved in the background of the present invention;

FIG. 20 is a graphic presentation of “an inclined plane slider model of the principle of the existing thread technology-the principle of inclined plane” involved in the background of the present invention; and

FIG. 21 is a graphic presentation of “a thread rise angle of the existing thread technology” involved in the background of the present invention.

In the figures, tapered thread 1, cylindrical body 2, nut body 21, columnar body 3, screw body 31, tapered hole 4, bidirectional tapered hole 41, conical surface 42 of the tapered hole, first helical conical surface 421 of the tapered hole, first taper angle α1, second helical conical surface 422 of the tapered hole, second taper angle α2, internal helical line 5, internal thread 6, truncated cone body 7, bidirectional truncated cone body 71, conical surface 72 of the truncated cone body, first helical conical surface 721 of the truncated cone body, first taper angle α1, second helical conical surface 722 of the truncated cone body, second taper angle α2, external helical line 8, external thread 9, olive-like shape 93, dumbbell-like shape 94, left taper 95, right taper 96, left-direction distribution 97, right-direction distribution 98, thread connection pair and/or thread pair 10, internal cone body 13, external cone body 14, axial force 15, counter-axial force 16, centripetal force 17, counter-centripetal force 18, external load 19, taper angle α, half taper angle ½ α, axial force angle β1, counter-axial force angle β2, clearance 101, cone axis 01, thread axis 02, slider A on the inclined surface, inclined surface B, gravity G, gravity component G1 along the inclined plane, friction force F, thread rise angle φ, equivalent friction angle P, major diameter d of the traditional external thread, minor diameter dl of the traditional external thread and pitch diameter d2 of the traditional external thread.

### DETAILED DESCRIPTION OF PREFERRED EMBODIMENTS

The present invention will be further described in detail below with reference to the accompany drawings and specific embodiments.

### Embodiment 1

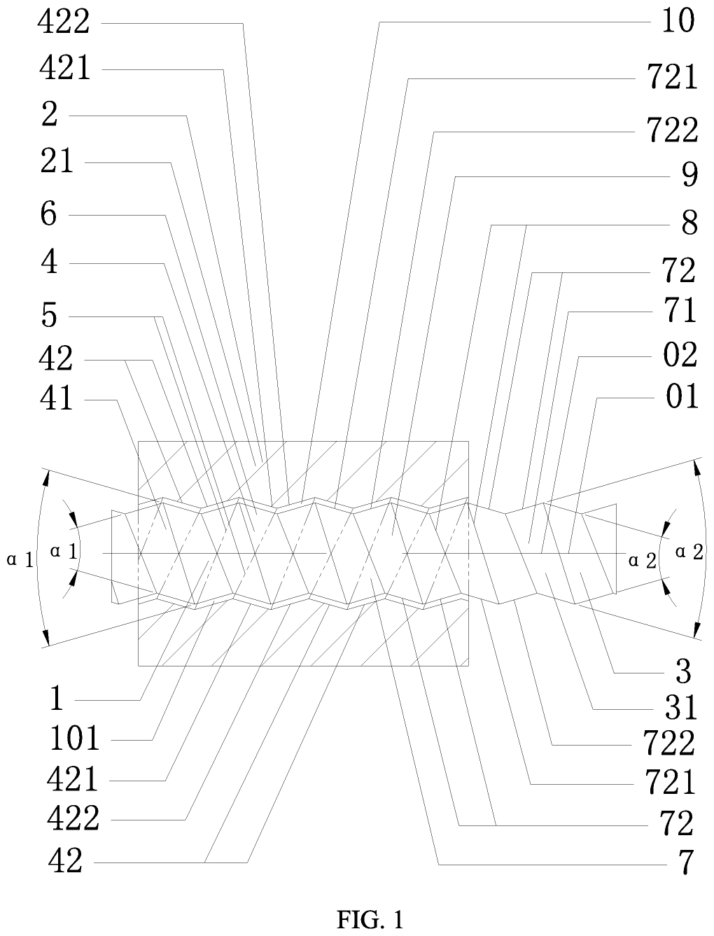

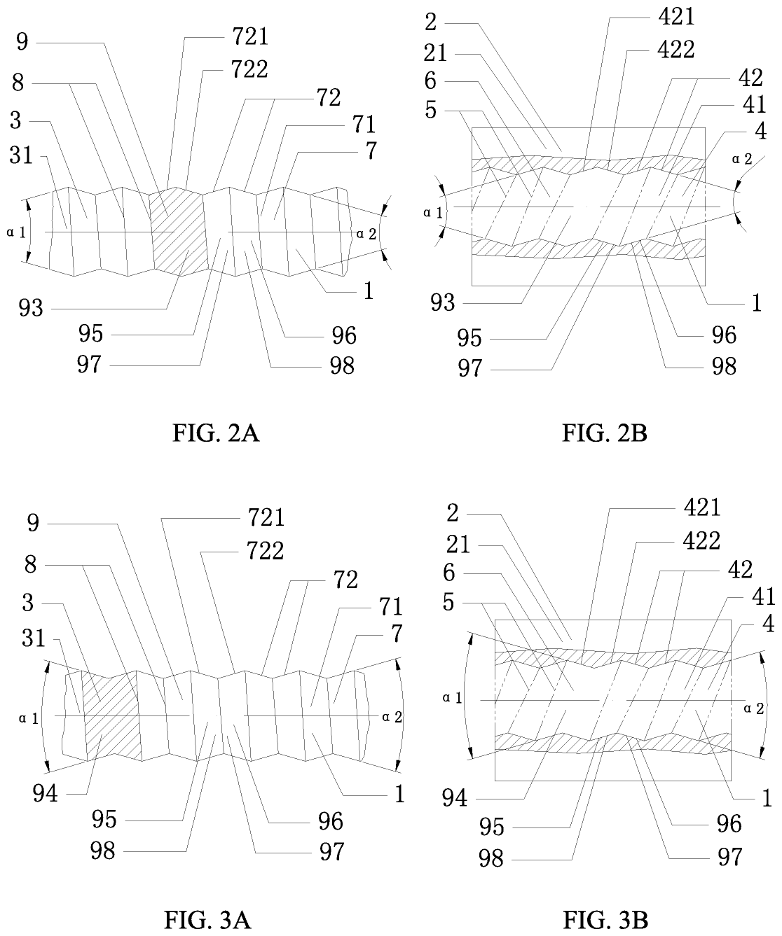

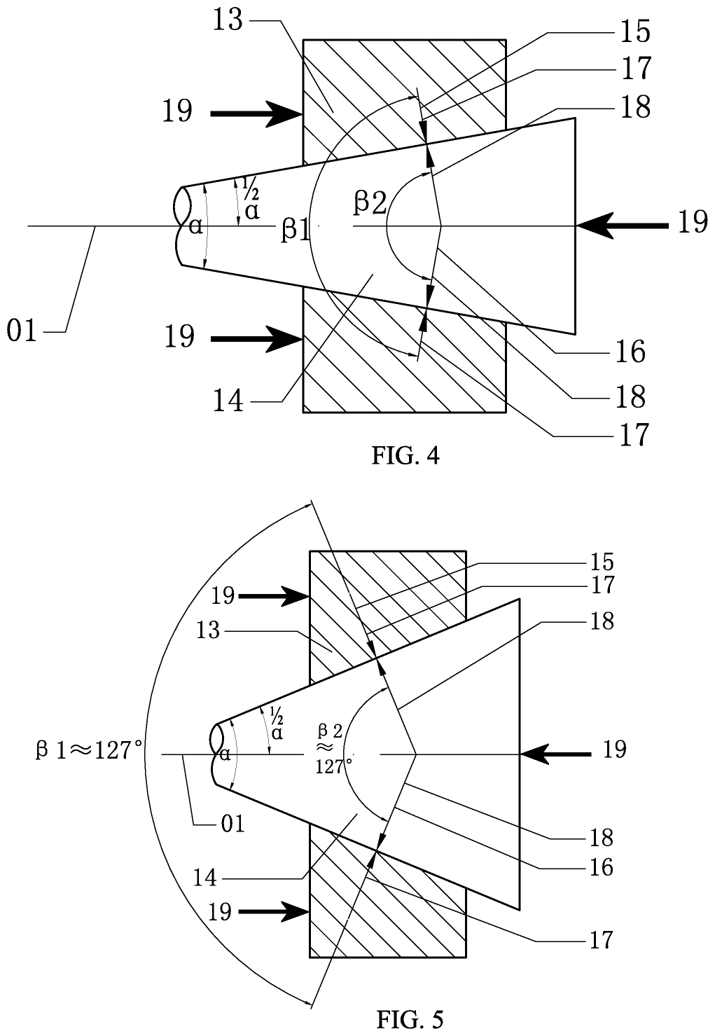

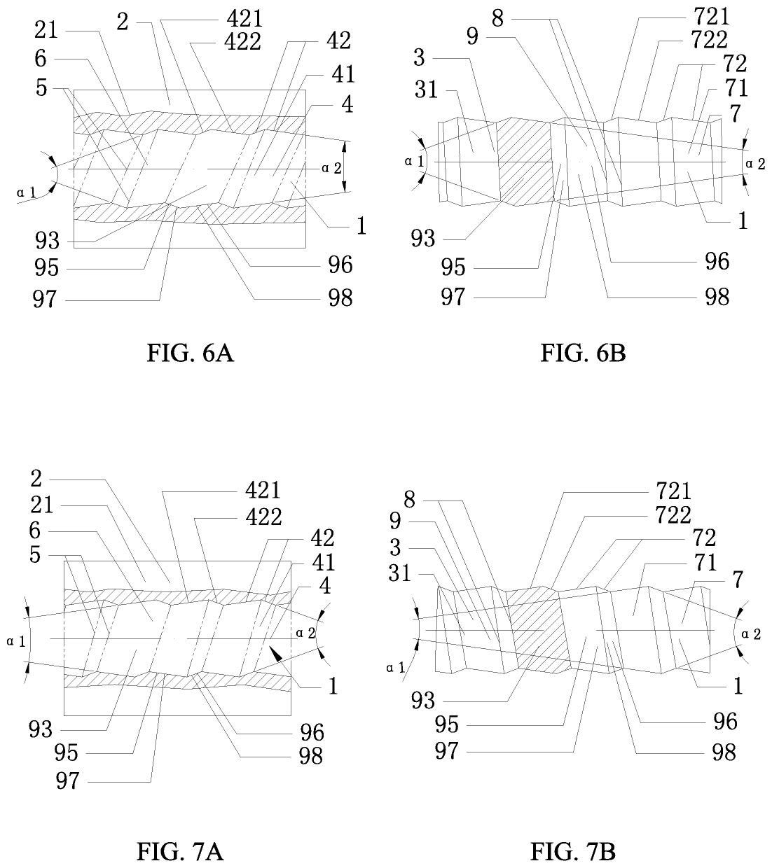

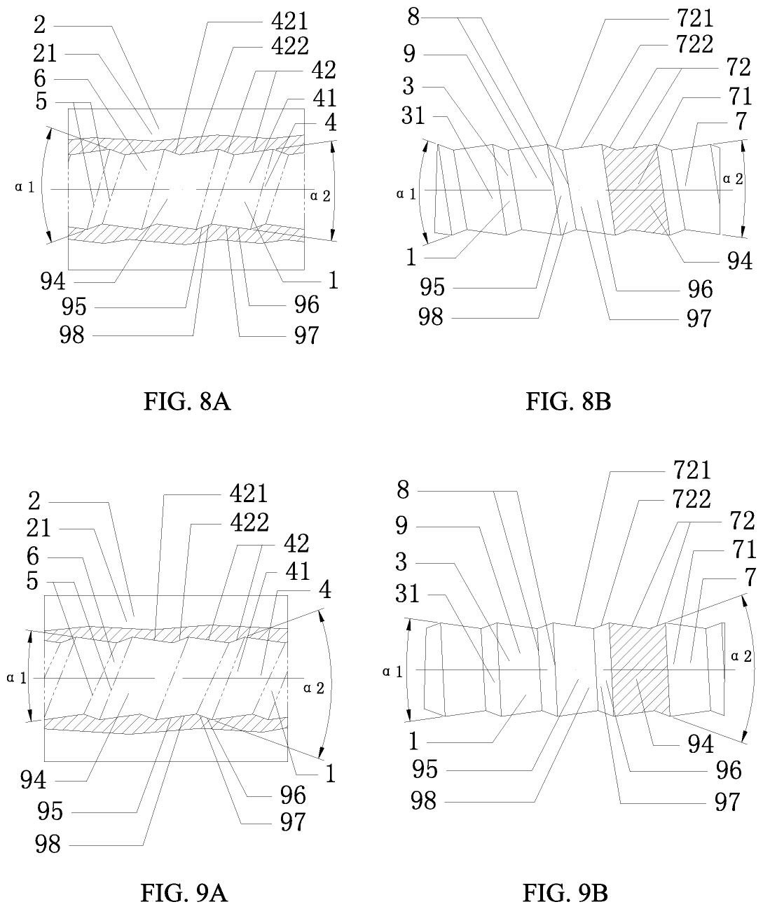

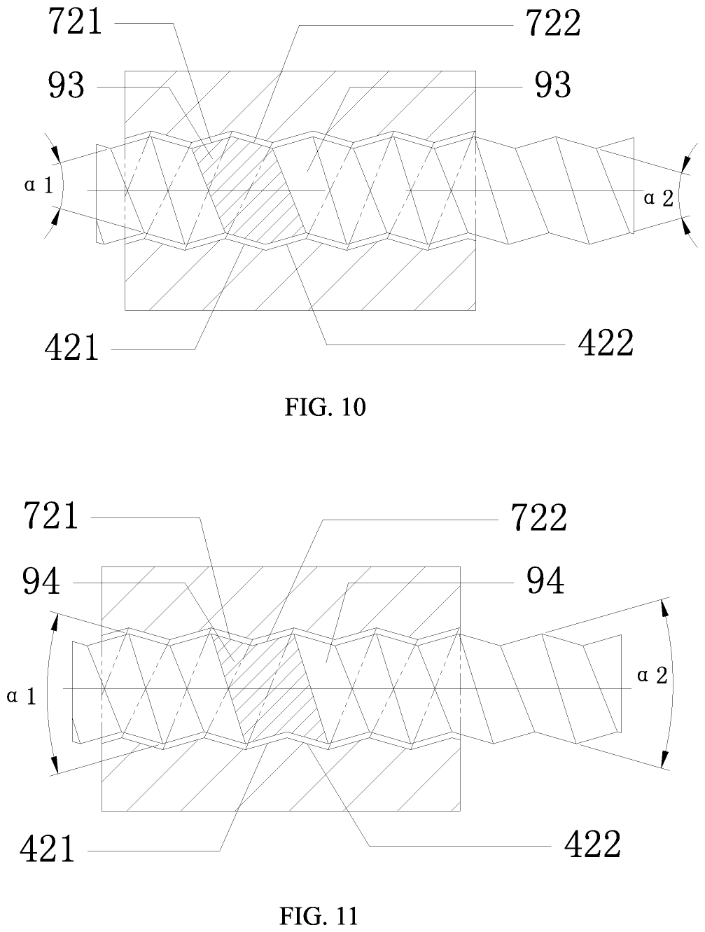

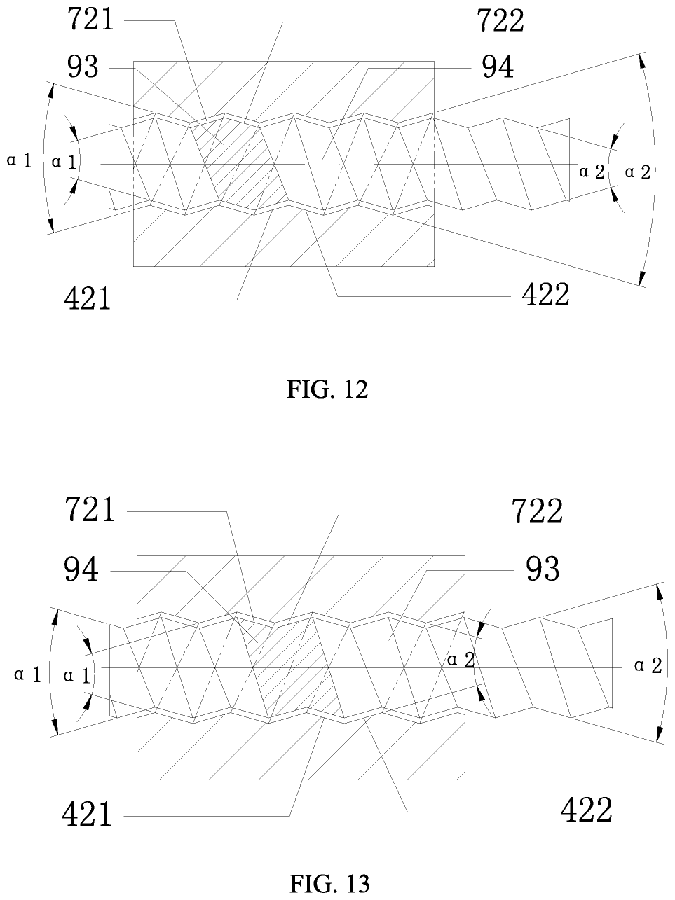

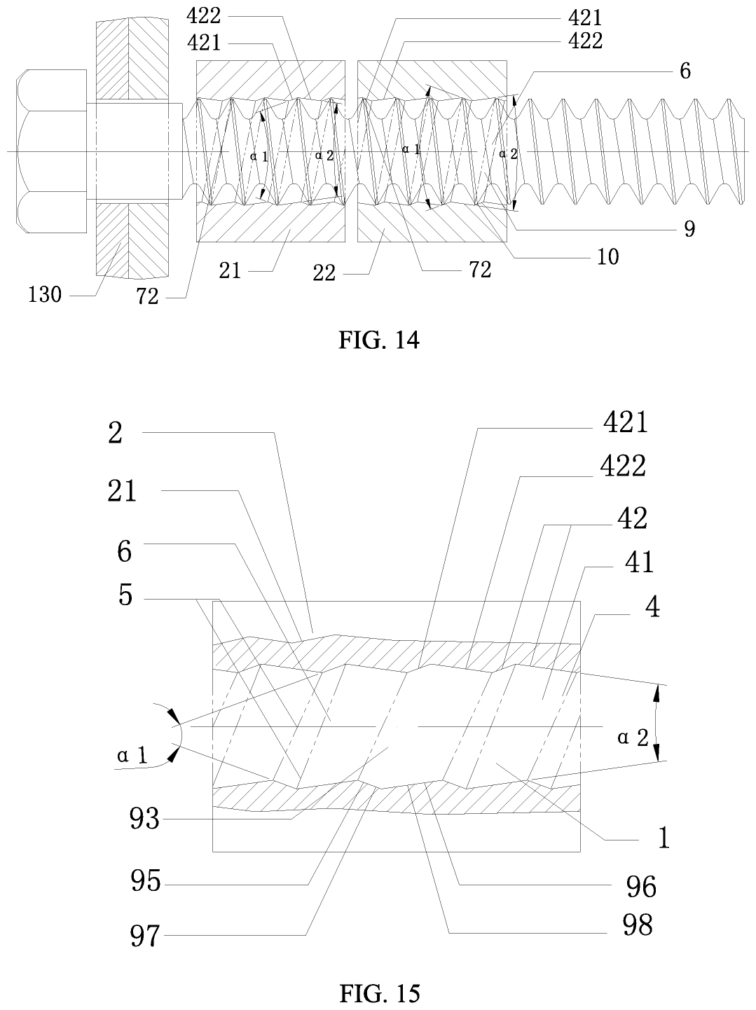

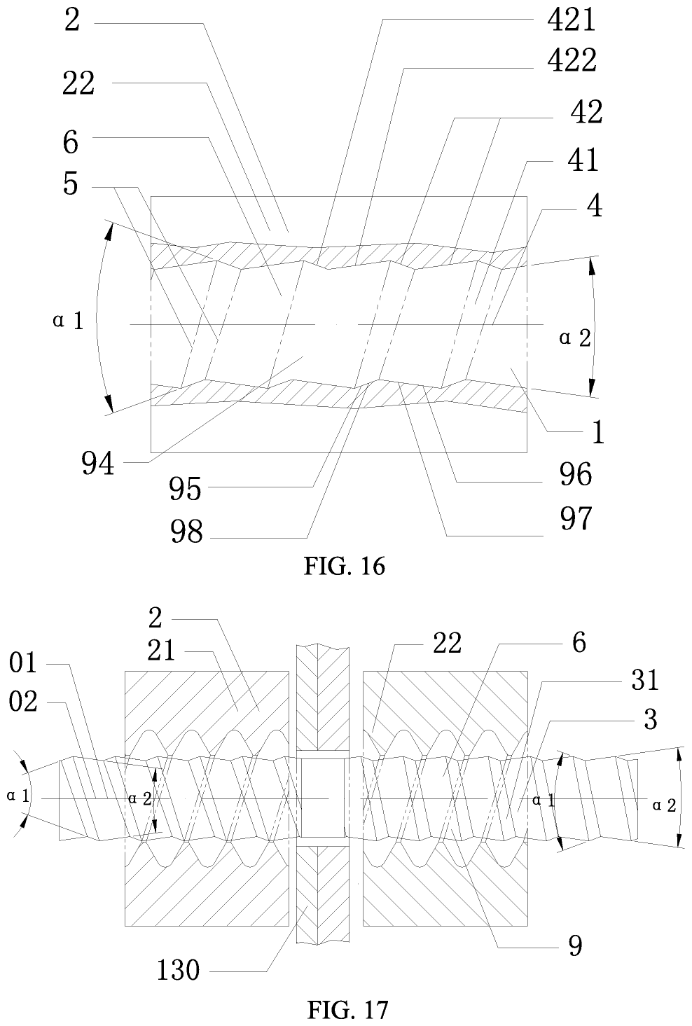

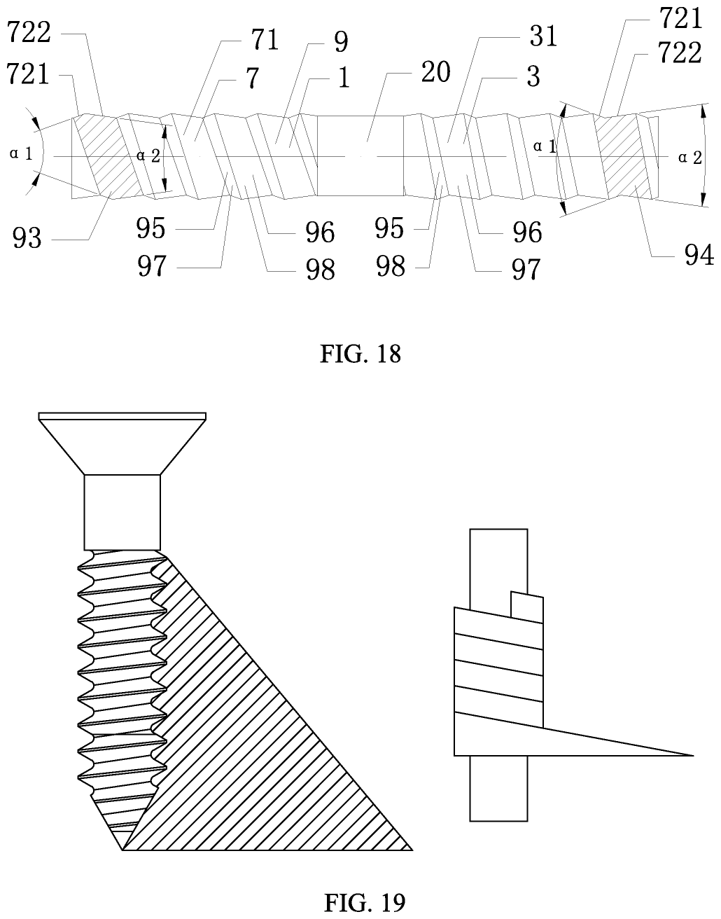

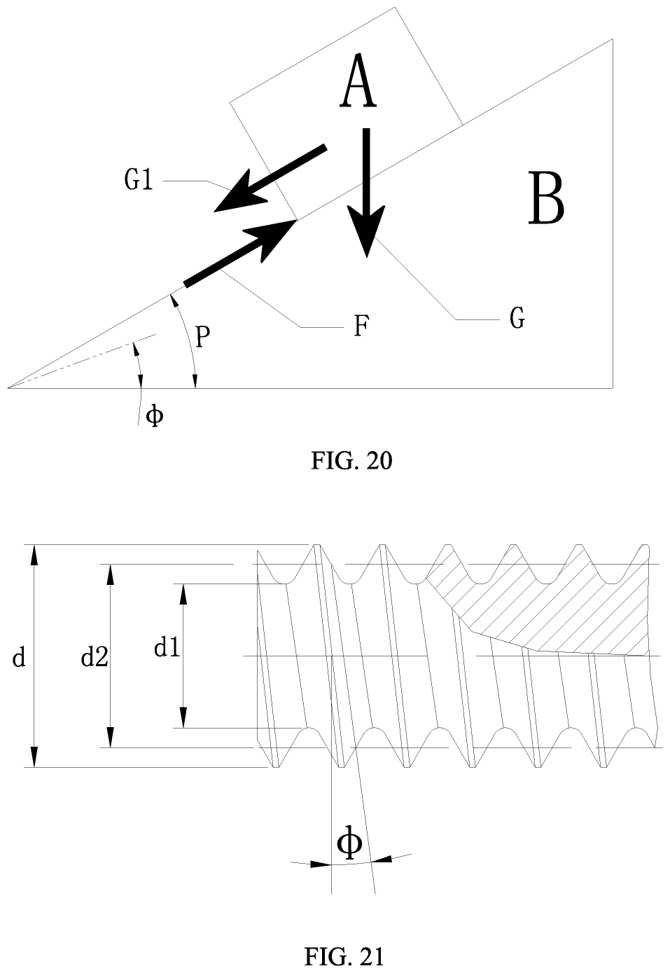

As shown in FIGS. 1, 2 and 3 and detail drawings of FIG. 1 comprising FIGS. 10, 11, 12 and 13, a thread connection pair 10 of a bidirectional tapered thread technology comprises a bidirectional truncated cone body 71 helically distributed on an outer surface of a columnar body 3 and a bidirectional tapered hole 41 helically distributed in an inner surface of a cylindrical body 2, namely, comprises an external thread 9 and an internal thread 6 which are in mutual thread fit. The internal thread 6 is distributed as a helical bidirectional tapered hole 41; and the external thread 9 is distributed as a helical bidirectional truncated cone body 71. The internal thread 6 presents the helical bidirectional tapered holes 41 and exists in the form of “non-entity space”; and the external thread 9 presents the helical bidirectional truncated cone bodies 71 and exists in the form of “material entity”. The internal thread 6 and the external thread 9 are subjected to a relationship of containing part and contained part as follows: the internal thread 6 and the external thread 9 are fitted together by screwing bidirectional tapered geometries pitch by pitch and cohered till an interference fit is achieved, i.e., the bidirectional tapered hole 41 contains the bidirectional truncated cone body 71 pitch by pitch. The bidirectional containment limits a disordered degree of freedom between the tapered hole 4 and the truncated cone body 7; and the helical movement enables the thread connection pair 10 of the bidirectional tapered thread technology to obtain a necessary ordered degree of freedom.

When the thread connection pair 10 of the bidirectional tapered thread technology is used, a conical surface 72 of the bidirectional truncated cone body and the conical surface 42 of the bidirectional tapered hole are fitted with each other.

The thread connection pair 10 of the bidirectional tapered thread technology in the present embodiment has the self-locking and self-positioning performances only if the truncated cone body 7 and/or the tapered hole 4 reaches a certain taper, i.e., cone bodies forming the cone pair reach a certain taper angle. The taper comprises a left taper 95 and a right taper 96. The taper angle comprises a left taper angle and a right taper angle. In the present embodiment, the left taper 95 and the right taper 96 are the same or approximately the same, and the tapered thread comprises a symmetric bidirectional tapered thread 1 having an olive-like shape 93 and a symmetric bidirectional tapered thread 1 having a dumbbell-like shape 94. The left taper 95 corresponds to the left taper angle, i.e., a first taper angle α1.

It is preferable that the first taper angle α1 is greater than 0° and smaller than 53°; and preferably, the first taper angle α1 is 2°-40°. The right taper 96 corresponds to the right taper angle, i.e., a second taper angle α2. It is preferable that the second taper angle α2 is greater than 0° and smaller than 53°; and preferably, the second taper angle α2 is 2°-40°.

In individual special fields, i.e., transmission connection application fields without self-locking and/or with low requirements on self-positioning performances and/or in which anti-lock measures are set, t is preferable that the first taper angle α1 is greater than or equal to 53° and smaller than 180°, and the second taper angle α2 is greater than or equal to 53° and smaller than 180°. It is preferable that the first taper angle α1 is greater than or equal to 53° and smaller than and equal to 90°; and the second taper angle α2 is greater than or equal to 53° and smaller than and equal to 90°.

The external thread 9 is arranged on the outer surface of the columnar body 3, wherein the columnar body 3 is provided with a screw body 31; the truncated cone body 7 is helically distributed on the outer surface of the screw body 31; and the truncated cone body 7 comprises the bidirectional truncated cone body 71, which has two structural forms, i.e., one is a special bidirectional tapered geometry in the olive-like shape 93, and the other is a special bidirectional tapered geometry in the dumbbell-like shape 94. The columnar body 3 may be solid or hollow, comprising workpieces and objects like cylinders, cones and tubes that need to be machined with threads on outer surfaces thereof

The symmetric bidirectional truncated cone body 71 in the olive-like shape 93, i.e., the external thread body, is formed by symmetrically and oppositely jointing lower bottom surfaces of two same truncated cone bodies. The upper top surfaces are located at both ends of the bidirectional truncated cone body 71 to form the symmetric bidirectional tapered thread 1, the process comprises that the lower bottom surfaces are respectively jointed with the upper top surfaces of the adjacent bidirectional truncated cone bodies 71 and/or to be respectively jointed with the upper top surfaces of the adjacent bidirectional truncated cone bodies 71. The external thread 9 comprises a first helical conical surface 721 of the truncated cone body, a second helical conical surface 722 of the truncated cone body and an external helical line 8, which form a symmetric bidirectional tapered external thread 9. In the cross section passing through the thread axis 02, a complete single-pitch symmetric bidirectional tapered external thread 9 is a special bidirectional tapered geometry in the olive-like shape 93 and with a large middle and two small ends. The bidirectional truncated cone bodies 71 include conical surfaces 72 of symmetric bidirectional truncated cone bodies. The angle formed between two plain lines of the left conical surface of the asymmetric bidirectional truncated cone body 71, i.e., the first helical conical surface 721 of the truncated cone body, is the first taper angle α1. The left taper 95 formed on a first helical conical surface 721 of the truncated cone body is subjected to a left-direction distribution 97. The angle formed between the two plain lines of the right conical surface of the asymmetric bidirectional truncated cone body 71, i.e., the second helical conical surface 722 of the truncated cone body, is the second taper angle α2, i.e., the right taper angle corresponding to the right taper 96 of the external thread 9 of the asymmetric bidirectional tapered thread, wherein the right taper 96 is subjected to a right-direction distribution 98. The taper directions corresponding to the first taper angle α1 and the second taper angle α2 are opposite. The plain line is an intersection line of the conical surface and the plane through which the cone axis 01 passes. The shape formed by the first helical conical surface 721 and the second helical conical surface 722 of the truncated cone body of the bidirectional truncated cone body 71 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body 3, wherein the right-angled side is coincident with the central axis of the columnar body 3; and the right-angled trapezoid union is formed by symmetrically and oppositely jointing lower sides of two same right-angled trapezoids. The right-angled trapezoid union refers to a special geometry, which is formed by symmetrically and oppositely jointing the lower sides of two same right-angled trapezoids and has the upper sides respectively located at both ends of the right-angled trapezoid union.

The symmetric bidirectional truncated cone body 71 in the dumbbell-like shape 94, i.e., the external thread, is formed by symmetrically and oppositely jointing the upper top surfaces of two same truncated cone bodies, and the lower bottom surfaces are located at both ends of the bidirectional truncated cone body 71 to form the symmetric bidirectional tapered thread 1, comprising that the lower bottom surfaces of the bidirectional truncated cone body 71 are respectively jointed with the lower bottom surfaces of the adjacent bidirectional truncated cone bodies 71 and/or to be respectively jointed with the lower bottom surfaces of the adjacent bidirectional truncated cone bodies 71. The external thread 9 comprises a first helical conical surface 721 of the truncated cone body as well as a second helical conical surface 722 of the truncated cone body and an outer helical line 8 so as to form a symmetric bidirectional tapered external thread 9. In a cross section through which the thread axis 02 passes, a complete single-pitch symmetric bidirectional tapered external thread 9 is a special bidirectional tapered geometry in the dumbbell-like shape 94 small in the middle and large in both end. The symmetric bidirectional truncated cone body 71 comprises a conical surface 72 of the symmetric bidirectional truncated cone body. The angle formed between the two plain lines of the left conical surface of the asymmetric bidirectional truncated cone body 71, i.e., the first helical conical surface 721 of the truncated cone body, is the first taper angle α1. The left taper 95 is formed on the first helical conical surface 721 of the truncated cone body and is subjected to a right-direction distribution 98. The angle formed by the two plain lines of the right conical surface of the symmetric bidirectional truncated cone body 71, i.e., the second helical conical surface 722 of the truncated cone body, is the second taper angle α2. The right taper 96 is formed on the second helical conical surface 722 of the truncated cone body and is subjected to a left-direction distribution 97. The taper directions corresponding to the first taper angle α1 and the second taper angle α2 are opposite. The plain line is an intersection line of the conical surface and the plane through which the cone axis 01 passes. The shape formed by the first helical conical surface 721 and the second helical conical surface 722 of the truncated cone body of the bidirectional truncated cone body 71 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body 3, wherein the right-angled side is coincident with the central axis of the columnar body 3. The right-angled trapezoid union refers to a special geometry, which is formed by symmetrically and oppositely jointing the upper sides of two same right-angled trapezoids and has the lower sides respectively located at both ends of the right-angled trapezoid union.

The internal thread 6 is arranged in the inner surface of the cylindrical body 2, wherein the cylindrical body 2 comprises a nut body 21 and a nut body 22; the tapered hole 4 is helically distributed in the inner surfaces of the nut body 21 and the nut body 22; and the tapered hole 4 comprises the symmetric bidirectional tapered holes 41. Each symmetric bidirectional tapered hole 41 has two structural forms, i.e., one is a special bidirectional tapered geometry in the olive-like shape 93, and the other is a special bidirectional tapered geometry in the dumbbell-like shape 94. The cylindrical body 2 comprises cylindrical and/or non-cylindrical workpieces and objects which need to be machined with the internal threads in the inner surfaces.

The symmetric bidirectional tapered hole 41 in the olive-like shape 93, i.e., the internal thread, is formed by symmetrically and oppositely jointing lower bottom surfaces of two same tapered holes. The upper top surfaces are located at both ends of the bidirectional tapered hole 41 to form the symmetric bidirectional tapered thread 1, the process comprises that the upper top surfaces are respectively jointed with the upper top surfaces of the adjacent bidirectional tapered holes 41 and/or to be respectively jointed with the lower bottom surfaces of the adjacent bidirectional tapered holes 41. The internal thread 6 comprises the first helical conical surface 421 of the tapered hole, the second helical conical surface 421 of the tapered hole and the internal helical line 5, which form the symmetric bidirectional tapered internal thread 6. In the cross section passing through the thread axis 02, the complete single-pitch symmetric bidirectional tapered internal thread 6 is a special bidirectional tapered geometry in the olive-like shape 93 and with a large middle and small large ends. The symmetric bidirectional tapered holes 41 comprises conical surfaces of the symmetric bidirectional tapered holes. The angle formed by the two plain lines of the left conical surface of the bidirectional tapered hole 41, i.e., the first helical conical surface 421 of the tapered hole, is the first taper angle α1. The left taper 95 is formed on the first helical conical surface 421 of the tapered hole and is subjected to the left-direction distribution 97. The angle formed by the two plain lines of the right conical surface of the bidirectional tapered hole 41, i.e., the second helical conical surface 422 of the tapered hole, is the second taper angle α2. The right taper 96 is formed on the second helical conical surface 422 of the tapered hole and is subjected to the right-direction distribution 98. The taper directions corresponding to the first taper angle α1 and the second taper angle α2 are opposite. The plain line is an intersection line of the conical surface and the plane through which the cone axis 01 passes. The shape formed by the first helical conical surface 421 and the second helical conical surface 422 of the tapered hole of the bidirectional tapered hole 41 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body 2, wherein the right-angled side is coincident with the central axis of the cylindrical body 2. The right-angled trapezoid union refers to a special geometry, which is formed by symmetrically and oppositely jointing the lower sides of two same right-angled trapezoids and has the upper sides respectively located at both ends of the right-angled trapezoid union.

The symmetric bidirectional tapered hole 41 in the dumbbell-like shape 94, i.e., the internal thread, is formed by symmetrically and oppositely jointing the upper top surfaces of two same tapered holes, and the lower bottom surfaces are located at both ends of the bidirectional tapered hole 41 to form the symmetric bidirectional tapered thread 1, comprising that the lower bottom surfaces of the bidirectional tapered hole 41 are respectively jointed with the lower bottom surfaces of the adjacent bidirectional tapered holes 41 and/or to be respectively jointed with the lower bottom surfaces of the adjacent bidirectional tapered holes 41. The internal thread 6 comprises a first helical conical surface 421 of the tapered hole as well as a second helical conical surface 422 of the tapered hole and an inner helical line 5 so as to form the symmetric bidirectional tapered internal thread 6. In the cross section passing through the thread axis 02, the complete single-pitch symmetric bidirectional tapered internal thread 6 is a special bidirectional tapered geometry in the dumbbell-like shape 94 and with a small middle and two large ends. The symmetric bidirectional tapered holes 41 include conical surfaces 42 of the symmetric bidirectional tapered holes. The angle formed between the two plain lines of the left conical surface of the asymmetric bidirectional tapered hole 41, i.e., the first helical conical surface 421 of the tapered hole, is the first taper angle α1. The left taper 95 is formed on the first helical conical surface 421 of the tapered hole and is subjected to a right-direction distribution 98. The angle formed by the two plain lines of the right conical surface of the symmetric bidirectional tapered hole 41, i.e., the second helical conical surface 422 of the tapered hole, is the second taper angle α2. The right taper 96 is formed on the second helical conical surface 422 of the tapered hole and is subjected to a left-direction distribution 97. The taper directions corresponding to the first taper angle α1 and the second taper angle α2 are opposite. The plain line is an intersection line of the conical surface and the plane through which the cone axis 01 passes. The shape formed by the first helical conical surface 421 and the second helical conical surface 422 of the tapered hole of the bidirectional tapered hole 41 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body 2, wherein the right-angled side is coincident with the central axis of the cylindrical body 2. The right-angled trapezoid union refers to a special geometry, which is formed by symmetrically and oppositely jointing the upper sides of two same right-angled trapezoids and has the lower sides respectively located at both ends of the right-angled trapezoid union.

According to bidirectional tapered thread technology in the present embodiment, the internal thread 6 and the external thread 9 form the thread connection pair 10, i.e., the internal thread 6 and the external thread 9 are in mutual screw-thread fit, comprising: in case of a combination of the bidirectional tapered threads 1 in the olive-like shape 93 and/or a combination of bidirectional tapered threads 1 in the dumbbell-like shape 94 and/or a mixed combination of the bidirectional tapered threads 1 in the olive-like shape 93 and in the dumbbell-like shape 94 and/or a combination of the internal thread with the traditional external thread 9 to form the thread connection pair, the combination comprises a combination of the bidirectional tapered threads 1 in the olive-like shape 93 and/or a combination of the bidirectional tapered threads 1 in the dumbbell-like shape 94 and/or a mixed combination of the bidirectional tapered threads 1 in the olive-like shape 93 and the bidirectional tapered threads 1 in the dumbbell-like shape 94.

Therefore, the technical performances such as the transmission precision, the transmission efficiency, the load bearing capacity, the locking force of self-locking, the anti-loosening ability, the sealing performance and reusability of the mechanical mechanism using the thread connection pair 10 of the bidirectional tapered thread technology in the present embodiment are related to the sizes of the first helical conical surface 721 of the truncated cone body and the formed left taper 95, i.e., the first taper angle α1, the second helical conical surface 722 of the truncated cone body and the formed right taper 96, i.e., the second taper angle α2, the first helical conical surface 421 of the tapered hole and the formed left taper 95, i.e., the first taper angle α1, as well as the second helical conical surface 422 of the tapered hole and the formed right taper 96, i.e., the second taper angle α2.

Material friction coefficient, processing quality and application conditions of the columnar body 3 and the cylindrical body 2 also have a certain impact on the cone fit.

According to the bidirectional tapered thread technology, when the right-angled trapezoid union rotates a circle at a constant speed, the axial movement distance of the right-angled trapezoid union is at least double the length of the sum of the right-angled sides of two same right-angled trapezoids. The structure ensures that the first helical conical surface 721 and the second helical conical surface 722 of the truncated cone body as well as the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

According to the bidirectional tapered thread technology, when the right-angled trapezoid union rotates a circle at a constant speed, the axial movement distance of the right-angled trapezoid union is equal to the length of the sum of the right-angled sides of two same right-angled trapezoids. The structure ensures that the first helical conical surface 721 and the second helical conical surface 722 of the truncated cone body as well as the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

According to the bidirectional tapered thread technology, the first helical conical surface 721 of the truncated cone body and the second helical conical surface 722 of the truncated cone body are both continuous helical surfaces or discontinuous helical surfaces; and the first helical conical surface 421 of the tapered hole and the second helical conical surface 422 of the tapered hole are both continuous helical surfaces or discontinuous helical surfaces. Preferably, the first helical conical surface 721 of the truncated cone body and the second helical conical surface 722 of the truncated cone body as well as the first helical conical surface 421 of the tapered hole and the second helical conical surface 422 of the tapered hole are all continuous helical surfaces.

In the thread connection pair 10 of the bidirectional tapered thread technology, one end and/or two ends of the columnar body 3 may be a screw-in end of the cylindrical body 2 connecting hole. By virtue of contact between the first helical conical surface 421 of the internal thread 6 and the first helical conical surface 721 of the external thread 9 and/or interference fit and/or contact between the second helical conical surface 422 of the internal thread 6 and the second helical conical surface 722 of the external thread 9 and/or interference fit, a connecting function of the thread connection pair 10 in the thread technology for combining technical characteristics of the cone pair and the helix is realized.

In the thread connection pair 10 of the bidirectional tapered thread technology, a head with the size greater than an outer diameter of the columnar body 3 is arranged at one end of the columnar body 3, and/or a head with a size smaller than a minor diameter of the bidirectional tapered external thread 9 of the screw body 31 of the columnar body 3 is arranged at one end and/or two ends of the columnar body 3, wherein the connecting hole is a threaded hole formed in a nut body 21 and the nut body 22. Namely, the columnar body 3 connected with the head is a bolt; and the columnar body having no head and/or having heads at both ends smaller than the minor diameter of the bidirectional tapered external thread 9 and/or having no thread at the middle and having the bidirectional tapered external threads 9 at both ends is a stud, wherein the connecting hole is formed in the nut body 21 and the nut body 22.

Compared with the prior art, the bidirectional tapered thread technology has the advantages of reasonable design, simple structure, convenient operation, large locking force, high bearing capacity, excellent anti-loosening performance, high transmission efficiency and precision and good mechanical sealing effect, realizes the fastening and connecting functions through sizing of the cone pair formed by the internal cone and the external cone to achieve interference fit, can prevent loosening phenomenon during connection, and has self-locking and self-positioning functions.

The specific embodiments described herein are merely examples to illustrate the spirit of the present invention. Those skilled in the art of the present invention can make various modifications or supplements to the specific embodiments described or substitute with similar modes without deviating from the spirit of the present invention or going beyond the scope defined by the appended claims.

The terms such as tapered thread 1, cylindrical body 2, nut body 21, columnar body 3, screw body 31, tapered hole 4, bidirectional tapered hole 41, helical conical surface 42 of the tapered hole, first helical conical surface 421 of the tapered hole, first taper angle α1, second helical conical surface 422 of the tapered hole, second taper angle α2, internal helical line 5, internal thread 6, truncated cone body 7, bidirectional truncated cone body 71, conical surface 72 of the truncated cone body, first helical conical surface 721 of the truncated cone body, first taper angle α1, second helical conical surface 722 of the truncated cone body, second taper angle α2, external helical line 8, external thread 9, olive-like shape 93, dumbbell-like shape 94, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror image, workpiece 130, shaft sleeve, shaft, non-entity space, material entity, single tapered body, double tapered body, cone body, internal cone body 13, tapered hole, external cone body 14, tapered body, cone pair, helical structure, helical movement, complete unit thread, mechanical element, taper angle α, half taper angle ½ α, axial force 15, axial force angle β1, counter-axial force 16, counter-axial force angle β2, centripetal force 17, counter-centripetal force 18, external load 19, reversely collinear, internal stress, bidirectional force and unidirectional force are widely used, but the possibility of using other terms is not excluded. These terms are merely used to describe and explain the essence of the present invention more conveniently; and it is contrary to the spirit of the present invention to interpret the terms as any additional limitation.

We claim:

1. A bidirectional tapered thread for combining technical characteristics of a cone pair and a helix, comprising an internal thread (6) and/or an external thread (9), wherein the bidirectional tapered thread (1) comprises a bidirectional tapered hole (41) and/or a bidirectional truncated cone body (71);
the bidirectional tapered hole and/or the bidirectional truncated cone body have/has a left taper (95) and a right taper (96) on a surface of a column or a cone; wherein the left taper (95) is same or approximately same as the right taper (96); and/or the left taper (95) is greater than the right taper (96); and/or the left taper (95) is smaller than the right taper (96);
the left taper (95) and the right taper (96) have reverse and/or opposite taper directions, and same and/or different tapers;
the bidirectional tapered thread is the bidirectional tapered body helically distributed along a helical line continuously and/or discontinuously; a complete unit thread comprises an olive-like shaped bidirectional tapered thread and/or a dumbbell-like shaped bidirectional tapered thread;
a thread body of the internal thread (6) is the helical bidirectional tapered hole (41) on an inner surface of a cylindrical body (2), and exists in a form of a “non-entity space”;
a thread body of the external thread (9) is presented by the bidirectional truncated cone body (71) on an outer surface of a columnar body (3) and in the form of a “material entity”;
the left taper (95) formed by a left conical surface of the bidirectional tapered thread (1) corresponds to a first taper angle (α1), and the right taper (96) formed by a right conical surface corresponds to a second taper angle (α2);
the internal thread (6) and the external thread (9) are in thread fit to contain the bidirectional truncated cone body by the bidirectional tapered hole till an inner conical surface of the bidirectional tapered hole and an outer conical surface of the bidirectional truncated cone body bear each other.

2. The bidirectional tapered thread according to claim 1, wherein in the olive-like shaped bidirectional tapered thread (1), the internal thread (6) comprises a first helical conical surface (421) of the tapered hole, a second helical conical surface (422) of the tapered hole, and an internal helical line (5);
a first shape formed by the first helical conical surface (421) of the tapered hole and the second helical conical surface (422) of the tapered hole is the same as a shape of a helical outer flank of a first rotating body, wherein the first rotating body is formed by a first right-angled trapezoid union being rotated around a right-angled side of the first right-angled trapezoid union , and, at the same time, the first right-angled trapezoid union axially moves at a constant speed along a central axis of the cylindrical nut (2); wherein the first right-angled trapezoid union is formed by oppositely jointing two symmetrical lower sides of two right-angled trapezoids; wherein the two right-trapezoids have identical lower sides and upper sides, and same and/or different right-angled sides; wherein the two right-trapezoids are coincident with the central axis of the cylindrical nut (2);
the bidirectional tapered external thread (9) comprises a first helical conical surface (721) of the truncated cone body, a second helical conical surface (722) of the truncated cone body, and an external helical line (8);
a second shape formed by the first helical conical surface (721) of the truncated cone body and the second helical conical surface (722) of the truncated cone body, is the same as a shape of a helical outer flank of the rotating body, wherein the rotating body is formed by the first right-angled trapezoid union being rotated around the first right-angled side of the first right-angled trapezoid union , and, at the same time, the first right-angled trapezoid union axially moves at constant speed along the central axis of the columnar body (3); wherein the first right-angled trapezoid union is formed by oppositely jointing two symmetrical lower sides of two right-angled trapezoids; wherein the two right-trapezoids have identical lower sides and upper sides, and same and/or different right-angled sides; wherein the two right-trapezoids are coincident with the central axis of the columnar body (3);

3. The bidirectional tapered thread according to claim 1, wherein in the dumbbell-like shaped bidirectional tapered thread, the internal thread (6) comprises a first helical conical surface (421) of the tapered hole, a second helical conical surface (422) of the tapered hole, and an internal helical line (5);
a third shape formed by the first helical conical surface (421) of the tapered hole and the second helical conical surface (422) of the tapered hole is the same as a shape of a helical outer flank of a second rotating body; wherein the second rotating body is formed by a second right-angled trapezoid union being rotated around a right-angled side of the second right-angled trapezoid union, and, at the same time, the second right-angled trapezoid union axially moves at a constant speed along the central axis of the cylindrical nut (2); wherein the second right-angled trapezoid union is formed by oppositely jointing two symmetrical upper sides of two right-angled trapezoids; wherein the two right-trapezoids have identical lower sides and upper sides, and same and/or different right-angled sides; wherein the two right-trapezoids are coincident with the central axis of the cylindrical nut (2);
the external thread (9) comprises a first helical conical surface (721) of the truncated cone body, a second helical conical surface (722) of the truncated cone body, and an external helical line (8);
a fourth shape formed by the first helical conical surface (721) of the truncated cone body and the second helical conical surface (722) of the truncated cone body, is the same as the shape of a helical outer flank of the second rotating body, wherein the second rotating body is formed by the second right-angled trapezoid union being rotated around the right-angled side of the second right-angled trapezoid union, and, at the same time, the second right-angled trapezoid union axially moves at constant speed along the central axis of the columnar body (3); wherein the second right-angled trapezoid union is formed by oppositely jointing two symmetrical upper sides of the two right-angled trapezoids; wherein the two right-trapezoids have identical lower sides and upper sides, and same and/or different right-angled sides; wherein the two right-trapezoids are coincident with the central axis of the columnar body (3).

4. The bidirectional tapered thread according to claim 2, wherein when the right-angled trapezoid union rotates a circle at a constant speed, an axial movement distance of the right-angled trapezoid union is at least double a length of the sum of the right-angled sides of the two right-angled trapezoids of the right-angled trapezoid union.

5. The bidirectional tapered thread according to claim 2, wherein when the right-angled trapezoid union rotates a circle at a constant speed, an axial movement distance of the right-angled trapezoid union is equal to a length of the sum of the right-angled sides of the two right-angled trapezoids of the right-angled trapezoid union.

6. The bidirectional tapered thread according to claim 2, wherein the first helical conical surface (721) of the truncated cone body and the second helical conical surface (722) of the truncated cone body, and the external helical line (8) are continuous helical surfaces or discontinuous helical surfaces; and/or
the first helical conical surface (421) of the tapered hole and the second helical conical surface (422) of the tapered hole, and the internal helical line (5) are continuous helical surfaces or discontinuous helical surfaces.

7. The bidirectional tapered thread according to claim 1, wherein the olive-like shaped bidirectional tapered internal thread (6) is formed by oppositely jointing two symmetrical lower sides of two tapered holes, wherein the two tapered holes have identical lower sides and upper sides, and same and/or different taper height; wherein the upper sides of the two tapered holes are located at two ends of the bidirectional tapered holes (41), and are respectively jointed with the upper side of the adjacent bidirectional tapered holes;
the dumbbell-like shaped bidirectional tapered internal thread (6) is formed by oppositely jointing two symmetrical upper sides of two tapered holes (3), wherein the two tapered holes have identical lower sides and upper sides, and same and/or different taper height; wherein the lower sides of the two tapered holes are located at two ends of the bidirectional tapered holes (41), and are respectively jointed with the lower sides of the adjacent bidirectional tapered holes;
the olive-like shaped bidirectional tapered external thread (9) is formed by oppositely jointing two symmetrical lower sides of two truncated cone bodies, wherein the two truncated cone bodies have identical lower sides and upper sides, and same and/or different taper height; wherein the upper sides of the two truncated cone bodies are located at two ends of the bidirectional truncated cone body (41), and are respectively jointed with the upper side of the adjacent bidirectional truncated cone bodies;
the dumbbell-like shaped bidirectional tapered external thread (9) is formed by oppositely jointing two symmetrical upper bottom sides of two truncated cone bodies, wherein the two truncated cone bodies have identical lower sides and upper sides, and same and/or different taper height; wherein the lower sides of the two truncated cone bodies are located at two ends of the bidirectional truncated cone body (41), and are respectively jointed with the lower sides of the adjacent bidirectional truncated cone bodies.

8. The bidirectional tapered thread according to claim 1, wherein a mutual thread fit of the internal thread (6) and the external thread (9) which form the thread connection pair (10) comprises a combination of the olive-like shaped bidirectional tapered threads (1) and/or a combination of the dumbbell-like shaped bidirectional tapered threads (1) (94) and/or a combination of the olive-like shaped bidirectional tapered thread (1) and the dumbbell-like shaped bidirectional tapered threads (1);
when a mutual thread fit of a thread connection pair formed by the bidirectional tapered thread and the traditional external and internal threads comprises a combination of the olive-like shaped bidirectional tapered threads (1) and/or a combination of the dumbbell-like shaped bidirectional tapered threads (1) and/or a combination of the olive-lie shaped bidirectional tapered thread (1) and the dumbbell-like shaped bidirectional tapered thread.

9. The bidirectional tapered thread according to claim 1, wherein the bidirectional tapered internal thread (6) and/or the bidirectional tapered external thread (9) have the ability to assimilate traditional threads; the thread body of the external thread (9) is the truncated cone body (7) on the outer surface of the columnar body (3) and is presented in the form of “material entity”; the thread body of the internal thread (6) is the tapered hole (4) on the inner surface of the cylindrical body (2) and is presented in the form of “non-entity space”; the traditional threads comprise at least one of triangular threads, trapezoidal threads, sawtooth threads, rectangular threads and arc threads.

10. The bidirectional tapered thread according to claim 1, wherein the bidirectional tapered internal thread (6) and/or the bidirectional tapered external thread (9) may be used solely or combined with machines; wherein the machines comprise non-thread mechanical structures and/or mechanical elements.

11. The bidirectional tapered thread according to claim 1, wherein a pressure formed by the internal thread and the external thread under an external load when the internal thread (6) and external thread (9) form a thread pair (10) depends on the conical surface and the taper size of the thread body and is inversely proportional to a tangent of ½ taper angle of the first taper angle (α1) and/or the second taper angle (α2).

12. The bidirectional tapered thread according to claim 1, wherein the thread pair (10) is formed by the helical bidirectional tapered hole (41) and the helical bidirectional truncated cone body (71) fit under the guidance of the helical line to form the thread pair (10).

13. The bidirectional tapered thread according to claim 1, wherein the thread pair (10)is formed by the internal cone and the external cone fitted helically with each other and the helical conical contact surface being a bearing surface, and/or till a self-locking generated by a self-positioning contact and/or the interference fit .

14. The bidirectional tapered thread according to claim 1, wherein the bidirectional tapered internal thread (6) and/or the bidirectional tapered external thread (9) comprise that a single-pitch thread body is an incomplete unit thread.

15. The bidirectional tapered thread according to claim 1, wherein the columnar body (3) is solid or hollow, comprising cylindrical and/or non-cylindrical workpieces and objects that need to be machined with the bidirectional tapered external threads (9) on the outer surfaces;
the cylindrical body (2) comprises cylindrical and/or non-cylindrical workpieces and objects that need to be machined with the bidirectional tapered internal threads (6) on the inner surfaces; and
the outer surfaces and/or inner surfaces comprise cylindrical surfaces and/or non-cylindrical surfaces including conical surfaces.

16. The bidirectional tapered thread according to claim 1, wherein the internal thread (6) and the external thread (9) comprise single-start threads, double-start threads and multi-start threads.

17. The bidirectional tapered thread according to claim 1, wherein the internal thread (6) and the external thread (9) comprise left-hand threads and right-hand threads.

18. The bidirectional tapered thread according to claim 1, wherein when the left taper (95) is same or approximately same with the right taper (96), the first taper angle (α1) is greater than 0° and smaller than 53°, and the second taper angle (α2) is greater than 0° and smaller than 53°;
when the left taper (95) is greater than the right taper (96), the first taper angle (α1) is greater than 0° and smaller than 53°, and the second taper angle (α2) is greater than 0° and smaller than 53°;
when the left taper (95) is smaller than the right taper (96), the first taper angle (α1) is greater than 0° and smaller than 53° and the second taper angle (α2) is greater than 0° and smaller than 53°.

19. The bidirectional tapered thread according to claim 17, wherein when the left taper (95) is same or approximately same with the right taper (96), the first taper angle (α1) is greater than or equal to 53° and smaller than 180°; the second taper angle (α2) is greater than or equal to 53° and smaller than 180°;
when the left taper (95) is greater than the right taper (96), the first taper angle (α1) is greater than or equal to 53° and smaller than 180°;
when the left taper (95) is smaller than the right taper (96), the second taper angle (α2) is greater than or equal to 53° and smaller than 180°.
